(19) United States
(12) Patent Application Publication
(10) Pub. No.: US 2013/0076526 A1
(43) Pub. Date: Mar. 28, 2013

(54) SYSTEM AND METHOD FOR CORRECTION OF DOWNHOLE MEASUREMENTS

(71) Applicants: Frank Schuberth, Celle (DE); Andreas Hartmann, Celle (DE); Hans-Martin Maurer, Houston, TX (US); Hanno Reckmann, Nienhagen (DE)

(72) Inventors: Frank Schuberth, Celle (DE); Andreas Hartmann, Celle (DE); Hans-Martin Maurer, Houston, TX (US); Hanno Reckmann, Nienhagen (DE)

(73) Assignee: BAKER HUGHES INCORPORATED, Houston, TX (US)

(21) Appl. No.: 13/242,487

(22) Filed: Sep. 23, 2011

(51) Int. Cl. G01V 3/18

(52) U.S. Cl. 340/853.8

(57) ABSTRACT

A system for estimating downhole parameters includes: at least one parameter sensor disposed along a downhole component and configured to measure a parameter of one or more of a borehole and an earth formation and generate parameter data; and a processor in operable communication with the at least one parameter sensor, the processor configured to receive the parameter data and deformation data relating to deformation of the downhole component. The processor is configured to: generate a mathematical model of the downhole component deformation in real time based on pre-selected geometrical data representing the downhole component and the received deformation data; estimate, in real time, an alignment of the at least one parameter sensor relative to at least one of another parameter sensor and a desired alignment; and in response to estimating a misalignment of the at least one parameter sensor, correct the parameter data based on the misalignment.

### BACKGROUND

In downhole operations such as drilling, geosteering and measurement-while-drilling (MWD) operations, sensor devices are included with a borehole string that measure various parameters of a formation and/or a borehole. Such sensor devices are typically arranged to have a desired orientation or alignment, and resulting measurements are analyzed based on such alignments. Various environmental effects and downhole forces can cause bending or other deformation of a downhole component, and consequently can result in misalignment of sensors devices, which can negatively affect measurement data.

### SUMMARY

A system for estimating downhole parameters includes: at least one parameter sensor disposed along a downhole component and configured to measure a parameter of one or more of a borehole and an earth formation and generate parameter data; and a processor in operable communication with the at least one parameter sensor, the processor configured to receive the parameter data and deformation data representing at least one characteristic relating to deformation of the downhole component during a downhole operation. The processor is configured to: generate a mathematical model of the downhole component deformation in real time based on pre-selected geometrical data representing the downhole component and the received deformation data; estimate, in real time, an alignment of the at least one parameter sensor relative to at least one of another parameter sensor and a desired alignment; and in response to estimating a misalignment of the at least one parameter sensor, correct the parameter data based on the misalignment.

A method of estimating downhole parameters includes: measuring a parameter of one or more of a borehole and an earth formation and generating parameter data by at least one parameter sensor disposed along a downhole component; measuring at least one characteristic relating to deformation of the downhole component during a downhole operation and generating deformation data; receiving the parameter data and the deformation data by a processor in operable communication with the at least one parameter sensor; generating, by the processor, a mathematical model of the downhole component deformation in real time based on pre-selected geometrical data representing the downhole component and the received deformation data; estimating, in real time, an alignment of the at least one parameter sensor relative to at least one of another parameter sensor and a desired alignment; and in response to estimating a misalignment of the at least one parameter sensor, correcting the parameter data based on the misalignment.

### BRIEF DESCRIPTION OF THE DRAWINGS

The following descriptions should not be considered limiting in any way. With reference to the accompanying drawings, like elements are numbered alike:

FIG. 1 is a side cross-sectional view of an embodiment of a drilling and/or geosteering system;

FIG. 2 is a perspective view of a downhole tool including an array of directional sensors; and

FIG. 3 is a flow chart providing an exemplary method of predicting or estimating misalignment of a downhole tool or other downhole component.

### DETAILED DESCRIPTION

The systems and methods described herein provide for modeling of downhole component deformation, bending, orientation and/or alignment and correction of downhole sensor measurements. Examples of a downhole component include a drilling assembly, a drillstring, a downhole measurement tool and a bottomhole assembly (BHA). A method includes taking measurements of various forces and environmental parameters exerted on the downhole component and inputting such force measurements along with pre-selected geometric and mechanical property data to build a mathematical model of the component. These inputs may be used to generate a model that estimates deformation of the component along a selected length or portion of the component. In one embodiment, the method includes transmitting data to a processor and updating and/or generating the model in real time during a downhole operation. The model is configured to provide bending and other deformation information at sensor locations, as well as along portions of the component between sensors and otherwise away from the sensor locations. The model may be utilized by a user for real time correction of other downhole parameter measurements (e.g., formation evaluation measurements) based on an estimated alignment or misalignment of measurement devices such as formation evaluation (FE) sensors.

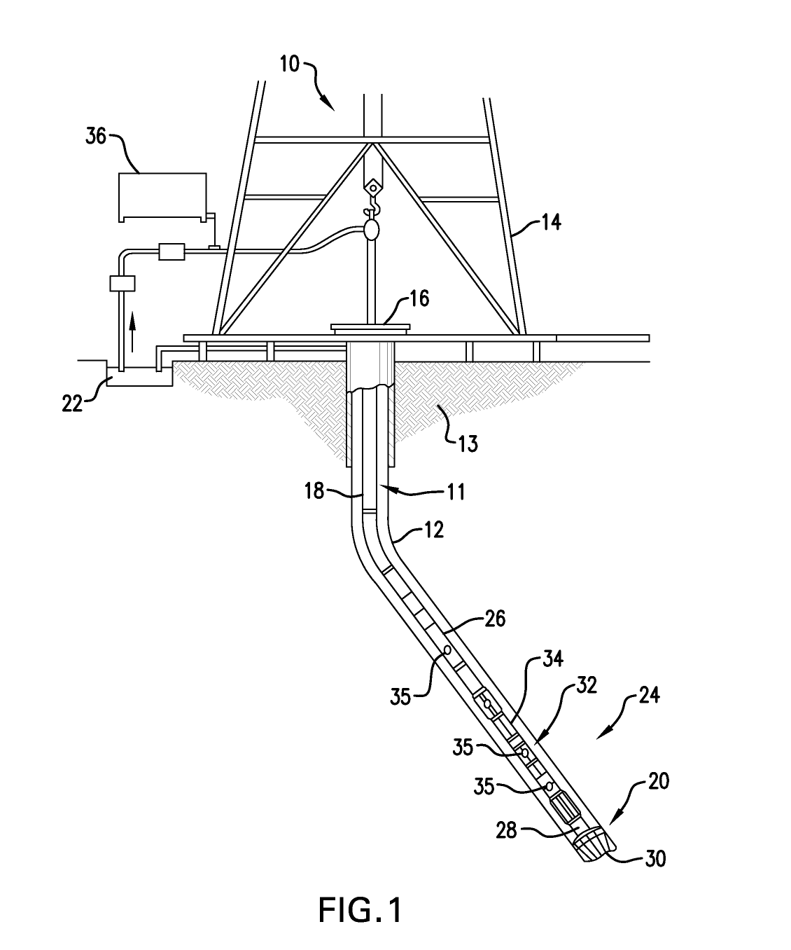

Referring to FIG. 1, an exemplary embodiment of a well drilling, logging and/or geosteering system 10 includes a drillstring 11 that is shown disposed in a wellbore or borehole 12 that penetrates at least one earth formation 13 during a drilling operation and makes measurements of properties of the formation 13 and/or the borehole 12 downhole. As described herein, “borehole” or “wellbore” refers to a single hole that makes up all or part of a drilled well. As described herein, “formations” refer to the various features and materials that may be encountered in a subsurface environment and surround the borehole.

In one embodiment, the system 10 includes a conventional derrick 14 that supports a rotary table 16 that is rotated at a desired rotational speed. The drillstring 11 includes one or more drill pipe sections 18 that extend downward into the borehole 12 from the rotary table 16, and is connected to a drilling assembly 20. Drilling fluid or drilling mud 22 is pumped through the drillstring 11 and/or the borehole 12. The well drilling system 10 also includes a bottomhole assembly (BHA) 24. In one embodiment, a drill motor or mud motor 26 is coupled to the drilling assembly 20 and rotates the drilling assembly 20 when the drilling fluid 22 is passed through the mud motor 26 under pressure.

In one embodiment, the drilling assembly 20 includes a steering assembly including a shaft 28 connected to a drill bit 30. The shaft 28, which in one embodiment is coupled to the mud motor, is utilized in geosteering operations to steer the drill bit 30 and the drillstring 11 through the formation.

In one embodiment, the drilling assembly 20 is included in the bottomhole assembly (BHA) 24, which is disposable within the system 10 at or near the downhole portion of the drillstring 11. The system 10 includes any number of downhole tools 32 for various processes including formation drilling, geosteering, and formation evaluation (FE) for measuring versus depth and/or time one or more physical quantities in or around a borehole. The tool 32 may be included in or embodied as a BHA, drillstring component or other suitable carrier. A “carrier” as described herein means any device, device component, combination of devices, media and/or member that may be used to convey, house, support or otherwise facilitate the use of another device, device component, combination of devices, media and/or member. Exemplary non-limiting carriers include drill strings of the coiled tubing type, of the jointed pipe type and any combination or portion thereof. Other carrier examples include casing pipes, wirelines, wireline sondes, slickline sondes, drop shots, downhole subs, bottom-hole assemblies, and drill strings.

In one embodiment, one or more downhole components, such as the drillstring 11, the downhole tool 32, the drilling assembly 20 and the drill bit 30, include sensor devices 34 configured to measure various parameters of the formation and/or borehole. For example, one or more parameter sensors 34 (or sensor assemblies such as MWD subs) are configured for formation evaluation measurements and/or other parameters of interest (referred to herein as “evaluation parameters”) relating to the formation, borehole, geophysical characteristics, borehole fluids and boundary conditions. These sensors 34 may include formation evaluation sensors (e.g., resistivity, dielectric constant, water saturation, porosity, density and permeability), sensors for measuring borehole parameters (e.g., borehole size, and borehole roughness), sensors for measuring geophysical parameters (e.g., acoustic velocity and acoustic travel time), sensors for measuring borehole fluid parameters (e.g., viscosity, density, clarity, rheology, pH level, and gas, oil and water contents), boundary condition sensors, and sensors for measuring physical and chemical properties of the borehole fluid.

The system 10 also includes sensors 35 for measuring force, operational and/or environmental parameters related to bending or other deformation of one or more downhole components. The sensors 35 are described collectively herein as “deformation sensors” and encompass any sensors, located at the surface and/or downhole, that provide measurements relating to bending or other deformation of a downhole component. Examples of deformation include deflection, rotation, strain, torsion and bending. Such sensors 35 provide data that is related to forces on the component (e.g., strain sensors, WOB sensors, TOB sensors) and are used to measure deformation or bending that could result in a change in position, alignment and/or orientation of one or more sensors 34.

For example, a distributed sensor system (DSS) is disposed at the drillstring 11 and BHA 24 includes a plurality of sensors 35. The sensors 35 perform measurements associated with forces on the drillstring that may result in bending or deformation, and can thereby result in misalignment of one or more sensors 35. Non-limiting example of measurements performed by the sensors 35 include accelerations, velocities, distances, angles, forces, moments, and pressures. Sensors 35 may also be configured to measure environmental parameters such as temperature and pressure. As one example of distribution of sensors, the sensors 35 may be distributed throughout a drill string and tool (such as a drill bit) at the distal end of the drill string 11. In other embodiments, the sensors 35 may be configured to measure directional characteristics at various locations along the borehole 12. Examples of such directional characteristics include inclination and azimuth, curvature, strain, and bending moment.

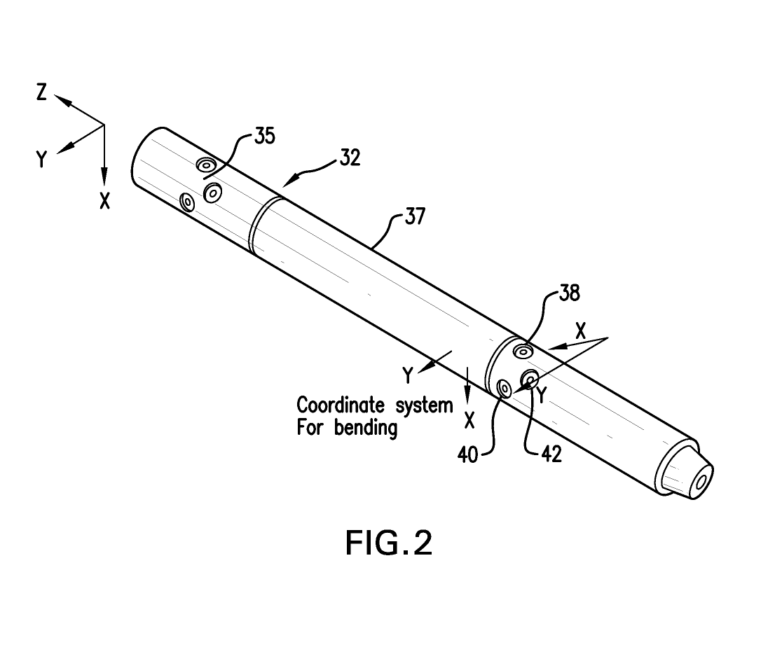

For example (shown in FIG. 2), one or more sensors 35 may be incorporated into a drilling sensor sub 37. This drilling sensor sub includes sensors for measuring measure weight on bit (WOB), torque on bit, annulus and internal pressure, and annulus and instrument temperature.

In one embodiment, the parameter sensors 34, deformation sensors 35 and/or other downhole components include and/or are configured to communicate with a processor to receive, measure and/or estimate directional and other characteristics of the downhole components, borehole and/or the formation. For example, the sensors 34, deformation sensors 35 and/or BHA 24 are equipped with transmission equipment to communicate with a processor such as a surface processing unit 36. Such transmission equipment may take any desired form, and different transmission media and connections may be used. Examples of connections include wired, fiber optic, acoustic, wireless connections and mud pulse telemetry.

The processor may be configured to receive data and generate information such as a mathematical model for estimating or predicting bending or other deformation of various components. For example, the processor is configured to receive downhole data as well as additional data (e.g., from a user or database) such as borehole size and geometric data of borehole components such as component size/shape and material. In one embodiment, the surface processing unit 36 is configured as a surface drilling control unit which controls various drilling parameters such as rotary speed, weight-on-bit, drilling fluid flow parameters and others and records and displays real-time formation evaluation data. The surface processing unit 36, the tool 32 and/or other components may also include components as necessary to provide for storing and/or processing data collected from various sensors therein. Exemplary components include, without limitation, at least one processor, storage, memory, input devices, output devices and the like.

Referring to FIG. 2, a downhole component is shown, such as a drill pipe section or BHA 24, that includes a plurality of deformation sensors 35 arrayed along an axis of the drillstring portion. In this example, each of the sensors 35 includes one or more strain gauges 38, 40 and 42 for measuring strain, which can be used to calculate deformation characteristics such as curvature, bending tool face angle and well toll face angle. Other non-limiting examples of sensors 35 include magnetometers and inclinometers configured to provide inclination data.

An exemplary orthogonal coordinate system includes a z-axis that corresponds to the longitudinal axis of the downhole component, and perpendicular x- and y-axes. In one embodiment, the sensors 35 are configured to take independent perpendicular bending moment measurements at selected cross-sectional locations of the tool 32. For example, the strain gauges 38 and 40 are configured to take bending moment measurements along the x-axis and y-axis, respectively.

Generally, some of the teachings herein are reduced to an algorithm that is stored on machine-readable media. The algorithm is implemented by a computer or processor such as the surface processing unit 36 or the tool 32 and provides operators with desired output. For example, electronics in the tool 32 may store and process data downhole, or transmit data in real time to the surface processing unit 36 via wireline, or by any kind of telemetry such as mud pulse telemetry or wired pipes during a drilling or measurement-while-drilling (MWD) operation

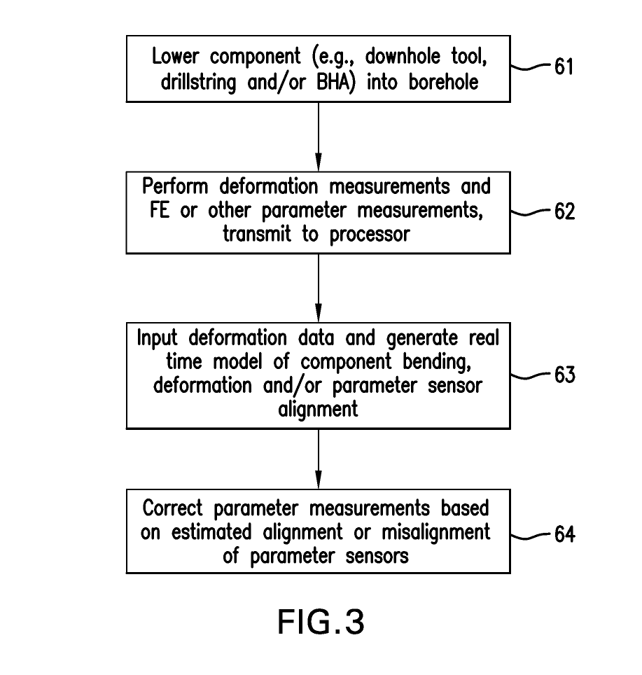

FIG. 3 illustrates a method 60 for estimating downhole parameters and correcting measurements based on modeled bending and/or deformation information. The method 60 includes one or more of stages 61-64 described herein, at least portions of which may be performed by a processor (e.g., the surface processing unit 36 or tool 32). In one embodiment, the method includes the execution of all of stages 61-64 in the order described. However, certain stages 61-64 may be omitted, stages may be added, or the order of the stages changed.

In the first stage 61, the downhole tool 34, the BHA 24 and/or the drilling assembly 20 are lowered into the borehole 12 during a drilling and/or directional drilling operation. Although the method is described herein as part of a drilling and geo-steering operation, it is not so limited, and may be performed with any desired downhole operation (e.g., a wireline operation).

In the second stage 62, various downhole measurements are performed during the drilling operation and transmitted to a processor, such as the surface processing unit 36. Various deformation measurements such as force or operation parameter measurements are obtained, such as weight on bit (WOB), torque-on-bit (TOB), steer force or orientation (e.g., bending sub or motor orientation). Other data relating to component bending or deformation may also be generated by the sensors 35, such as strain, bending moment, azimuth and/or inclination data. A distributed array of sensor devices 35 may be used to provide a plurality of measurements corresponding to a plurality of locations along the component. In one embodiment, these measurements are transmitted to the processor in real time or near real time. The measurements may be taken at least substantially continuously or periodically, and then transmitted (e.g., in real time) to the processor. Other measurements such as formation evaluation measurements may also be taken. In one embodiment, various sensor devices are incorporated into an integrated downhole tool or other component that measures various directional and evaluation parameters in real time as part of a MWD method.

In the third stage, 63 the deformation (e.g., force and/or operational measurement) data is input into an algorithm to generate and/or update a mathematical model of the position and forces on components such as the drill string 11 or portions thereof, the BHA 24, the tool 34 and the drilling assembly 20. The model is configured as a model of bending and/or deformation characteristics of the component. The model may be built using information including the geometrical layout of the downhole component(s), downhole component materials, the borehole trajectory and hole size, as well as real-time measurements of forces and bending/deformation measurements such as WOB, TOB and steer forces. In one embodiment, the location and orientation of various parameter (e.g., FE) sensors is also input into the model or otherwise used to estimate an alignment of each parameter sensor 34 relative to other sensors 34 on the drillstring. This data may be input to an algorithm for generating a model of the alignment or misalignment of the component(s).

The bending, deformation and alignment model uses the geometric data to generate representations of the geometry of one or more components and interactions between the components, as well as interactions between the components and the borehole wall, during operations such as drilling operations. The model is provided to allow users to simulate conditions and component interactions that are encountered during a drilling operation.

An exemplary model is generated using the finite element method. In one embodiment, a plurality of node elements are generated from the geometric data that correspond to the shape or geometry of different portions of the components. In one embodiment, one or more components are modeled as a three-dimensional model using finite elements such as geometrically nonlinear beam or mass elements.

In one embodiment, each node in the model is given a number of degrees of freedom (e.g., six degrees including three translations and three rotations), and is confined within an area representing the borehole 12 using a penalty function approach. Equations of motion can be used in conjunction with these degrees of freedom and may be integrated using an implicit, variable time step procedure. Systems of coupled, nonlinear equations of motion are used, which are integrated through time to obtain transient and steady state displacements, loads and stresses. Various input forces may be input such as weight-on-bit, drilling rotation speed, fluid pressure, mass imbalance forces, axial stresses, radial stresses, weights of various components, and structural parameters such as stiffness. The nodes and forces described herein are exemplary and not intended to be limiting. Any suitable forces desired to be modeled may be used.

The bending/deformation characteristic measurements (and any evaluation parameter measurements) may be received in real-time by the processor, and the processor may automatically, without user intervention, generate and/or update the model in real time using at least the deformation measurements. The measurements may be, for example, displayed and/or transmitted to a user to allow the user to build and/or update the model to estimate misalignment of any of the sensors 34 along a complete portion of the drill string. In one embodiment, the measurements are automatically received and processed by the processor, which automatically builds and/or updates the predictive model during the drilling operation.

In one embodiment, generation of the model includes calculating the alignment/misalignment of the sensors 34 at selected locations based on the deformation measurements and the bending model. For example, bending and misalignment are calculated using algorithms or software such as BHASysPro software developed by Baker Hughes, Inc.

In one embodiment, the model incorporates deformation measurements from an array of sensor devices 35 located along an axis of the component and measures deformation data at each of the sensor locations. The model provides deformation and bending information at locations between adjacent sensors 35 along the array. The model may therefore be a predictive model of deformation and bending of the complete component, both at sensor locations and substantially continuously at regions between and away from the sensor locations. This model may be generated/updated in real-time during the drilling process and utilized during the drilling process to correct parameter measurements.

The resulting model includes estimations of deformation (e.g., deflection, rotation, strain, torsion and/or bending) along a selected portion of the model, including portions of the model that are located between distributed sensors and/or portions that do not have a sensor disposed thereat. In this way, deformation and alignment or misalignment estimations may be generated along an entire portion of the component(s), including portions between sensors.

In one embodiment, other downhole measurements may be taken to validate the model or to further correct the model. For example, the sensors 35 shown in FIG. 2 may be included at selected discrete locations along the drill string, and strain and/or bending information is used to confirm bending estimations taken from the model. For example, actual bending moment measurements generated by the sensors 35 are compared to estimated bending moment measurements taken from the model to determine whether the model is accurate and/or that the estimations are within an acceptable range relative to actual measurements.

In the fourth stage 64, the model and alignment estimations for various sensors are utilized to correct downhole parameter measurements. For example, downhole measurement tools include multiple sensors 34 that are oriented to measure parameters of a borehole (e.g., resistivity). Such sensors 34 are configured to measure along the same axis or otherwise have a selected alignment relative to each other. Alignment information taken from the model is used to determine whether there is any misalignment of a sensor 34 relative to other sensors 34 and/or relative to a desired alignment. If a sensor 34 is found to be misaligned, the measurements resulting from the sensor 34 are adjusted or corrected by a user to compensate for such misalignment. As used herein, a “user” may include a drillstring or logging operator, a processing unit and/or any other entity selected to retrieve the data and/or control the drillstring 11 or other system for lowering tools into a borehole. In addition, the information from the model may also be used to correct geo-steering operations. The user may take any appropriate actions based on the model data to, for example, change steering course or drilling parameters.

As used herein generation of data in “real time” is taken to mean generation of data at a rate that is useful or adequate for making decisions during or concurrent with processes such as production, experimentation, verification, and other types of surveys or uses as may be opted for by a user. As a non-limiting example, real time measurements and calculations may provide users with information necessary to make desired adjustments during the drilling process. In one embodiment, adjustments are enabled on a continuous basis (at the rate of drilling), while in another embodiment, adjustments may require periodic cessation of drilling for assessment of data. Accordingly, it should be recognized that “real time” is to be taken in context, and does not necessarily indicate the instantaneous determination of data, or make any other suggestions about the temporal frequency of data collection and determination.

The systems and methods described herein provide various advantages over prior art techniques. For example, the systems and methods allow for real time estimation of downhole component misalignment (e.g., relative to the borehole and/or desired alignment) and correction of parameter measurements, and further provides for automatic updating of mathematical models of the component and the borehole to provide a complete picture of alignment both at locations of sensors and locations where sensors are not disposed. The misalignment can thus be predicted with a relatively low number of distributed sensors.

Other advantages include a stream-lined process for directly modeling misalignment to provide a predicted model of misalignment, which relieves a user of the additional steps of comparing alignment data to a pre-programmed model of the drillstring. Such characteristics allow for improved misalignment measurements of a complete drillstring closer in time to the actual measurements, which in turn allows for quicker correction of the drilling operation.

In support of the teachings herein, various analyses and/or analytical components may be used, including digital and/or analog systems. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

One skilled in the art will recognize that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A system for estimating downhole parameters, the system comprising:
at least one parameter sensor disposed along a downhole component and configured to measure a parameter of one or more of a borehole and an earth formation and generate parameter data; and
a processor in operable communication with the at least one parameter sensor, the processor configured to receive the parameter data and deformation data representing at least one characteristic relating to deformation of the downhole component during a downhole operation, the processor configured to:
generate a mathematical model of the downhole component deformation in real time based on pre-selected geometrical data representing the downhole component and the received deformation data;
estimate, in real time, an alignment of the at least one parameter sensor relative to at least one of another parameter sensor and a desired alignment; and
in response to estimating a misalignment of the at least one parameter sensor, correct the parameter data based on the misalignment.

2. The system of claim 1, further comprising one or more deformation sensors configured to measure the at least one characteristic.

3. The system of claim 1, wherein the characteristic is selected from at least one of a drilling parameter, a force, a load, a moment, and a torque.

4. The system of claim 3, wherein the drilling parameter selected from at least one of a weight-on-bit, a torque-on-bit and a steering force.

5. The system of claim 1, wherein the processor is configured to transmit alignment data generated from the model to a user to correct for the misalignment.

6. The system of claim 2, wherein the one or more deformation sensors is a plurality of sensors disposed at a plurality of sensor locations, and the mathematical model includes estimations of component deformation at each sensor location and at regions between each of the deformation sensor locations.

7. The system of claim 1, wherein the deformation is selected from at least one of deflection, rotation, strain, torsion and bending.

8. The system of claim 1, wherein the at least one parameter sensor is a formation evaluation (FE) sensor.

9. The system of claim 1, wherein the at least one parameter sensor is a plurality of parameter sensors.

10. The system of claim 9, wherein the model includes an estimate of an alignment of each of the plurality of parameter sensors relative to at least one of another parameter sensor and a desired alignment.

11. A method of estimating downhole parameters, the method comprising:
measuring a parameter of one or more of a borehole and an earth formation and generating parameter data by at least one parameter sensor disposed along a downhole component;
measuring at least one characteristic relating to deformation of the downhole component during a downhole operation and generating deformation data;
receiving the parameter data and the deformation data by a processor in operable communication with the at least one parameter sensor;
generating, by the processor, a mathematical model of the downhole component deformation in real time based on pre-selected geometrical data representing the downhole component and the received deformation data;
estimating, in real time, an alignment of the at least one parameter sensor relative to at least one of another parameter sensor and a desired alignment; and
in response to estimating a misalignment of the at least one parameter sensor, correcting the parameter data based on the misalignment.

12. The method of claim 11, wherein the downhole operation is at least one of a drilling and geo-steering operation, a formation evaluation operation, and a measurement-while-drilling operation.

13. The method of claim 11, wherein the characteristic is selected from at least one of a drilling parameter, a force, a load, a moment, and a torque.

14. The system of claim 13, wherein the drilling parameter selected from at least one of a weight-on-bit, a torque-on-bit and a steering force.

15. The method of claim 11, further comprising transmitting alignment data generated from the model to a user to correct for the misalignment.

16. The method of claim 11, wherein the model is generated using deformation data associated with each of a plurality of deformation sensor locations, and estimating the deformation at both the deformation sensor locations and at regions between each of the deformation sensor locations.

17. The method of claim 11, wherein the deformation is selected from at least one of deflection, rotation, strain, torsion and bending.

18. The method of claim 11, wherein the at least one parameter sensor is a formation evaluation (FE) sensor.

19. The method of claim 11, wherein the at least one parameter sensor is a plurality of parameter sensors.

20. The method of claim 19, wherein the model includes an estimate of an alignment of each of the plurality of parameter sensors relative to at least one of another parameter sensor and a desired alignment.
